(19) United States
(12) Patent Application Publication
(10) Pub. No.: US 2005/0240561 A1
(43) Pub. Date: Oct. 27, 2005

(54) Monitoring and controlling work progress

(75) Inventors: Sanjay Jain, Chappaqua, NY (US); Anthony Amato, Massapequa Park, NY (US)

Correspondence Address: NADA JAIN, P.C., 560 White Plains Road, Suite 460, Tarrytown, NY, 10591, US

(73) Assignee: DataLinx Corporation, Tarrytown, NY (US)

(21) Appl. No.: 11/113,565

(22) Filed: Apr. 25, 2005

Related U.S. Application Data
(60) Provisional application No. 60/565,051, filed on Apr. 24, 2004.

(51) Int. Cl. G06F 7/00

(52) U.S. Cl. 707/1

(57) ABSTRACT

The invention relates to products for, and methods of, monitoring and controlling work progress, and improving work productivity and work management, for example in highly variable and/or unpredictable work environments, and to products for, and methods of, interactive data processing particularly adapted for systems comprising a handheld mobile component

This application claims the benefit, under 35 USC Section 119, of the U.S. Provisional Appl. No. 60/565,051 filed Apr. 24, 2004, the disclosure of which is hereby incorporated herein by reference.

The invention relates to products for, and methods of, monitoring and controlling work progress, and improving work productivity and work management, for example in highly variable and/or unpredictable work environments, and to products for, and methods of, interactive data processing particularly adapted for systems comprising a handheld mobile component.

### BACKGROUND

The objective of a work management system is to deliver maximum productivity and predictability while ensuring a consistent and quality work process. Typical measures for these elements include: for productivity, number of defined tasks completed in unit time; for predictability, ability to manage the workload towards a pre-arranged work plan and timeline; for consistency, repeatability of steps and processes for similar work; and for quality, completion of work within established technical specifications with low recurrence of the problem.

In most work environments today, the workforce is minimally supervised and works on extremely large units of work. The tools and systems that support the workforce are inherently unable to drive up productivity on a daily basis and the minimal supervision results in low work predictability. Even when the work is to be performed according to a planned timeline, the low level of supervision does not allow for timely correction in situations when the work deviates from its planned timeline. The forces of business today do not allow for a high level of supervision and that exacerbates the problem. Moreover, today, all work related information is collected post completion of the work. The problem is particularly acute in inherently highly variable and unpredictable work environments, for example, where a mobile or a localized work force deals with unpredictable problems, such as those stemming from the particulars of a work location and/or specific technical problems and/or working with a client or customer.

In the work environments characterized by a mobile work force equipped with handheld devices, interactive data processing during a job performance has not be achieved to date given that handheld devices are limited in the amount of information they can receive and more importantly display at any given time.

Therefore, there is a need in the art to optimize work management with the objective to increase productivity, predictability, consistency and/or quality of work. Furthermore, there is a need to provide technical solutions for transmitting work data to a mobile force equipped with handheld devices, which are inherently not suitable for receiving and displaying large amounts of information. The invention described herein fills this unmet need.

### SUMMARY OF THE INVENTION

The invention relates to products for, and methods of, interactive data processing particularly adapted for systems comprising a handheld mobile component, and to products for, and methods of, monitoring and controlling work progress and/or execution of a job, for improving work productivity, predictability, consistency and/or quality, and for improving work management.

In one aspect, the invention relates to a method of improving work management comprising work tracking and monitoring, data collection and feedback.

In another aspect, the invention relates to a system for monitoring and controlling work progress and/or execution of a job, and to a processor comprising a job template or a fragment thereof. The system for interactive data processing comprises a central processor comprising an application loader, and a user processor comprising an application controller.

In yet another aspect, the invention relates to a software tool and a method of creating a library of job templates suitable for use in the systems and methods of the invention, and to a database comprising job templates.

### BRIEF DESCRIPTION OF THE DRAWINGS

FIG. 1 represents an example of a job template fragment.

FIG. 2 represents an exemplary data model of a job template fragment.

FIG. 3 represents an exemplary screen of the software tool of the invention with a “File” pull down menu.

FIG. 4 represents an exemplary screen of the software tool of the invention with a pull down menu accessed by right clicking on an empty potion of the canvas.

FIG. 5 represents an exemplary screen of the software tool with a menu available for each task in the Step Library.

FIG. 6 represents an exemplary screen with an example of job task template management.

FIG. 7 represents an exemplary task user interface creator window showing a sample display screen (see smaller window headed by a technician's name) to be communicated to and displayed on the screen of a user processor.

FIG. 8 represents an exemplary work flow containing conditions.

### DETAILED DESCRIPTION

The products and methods of the present invention may be used in any industry that can benefit from monitoring and controlling of a work process, for example, execution of a particular job. The invention is particularly useful for complex work environments, for example, when large units of work, i.e., work composed of multiple tasks, and/or unpredictable or variable work environments need to be managed. Examples of such industries include: telecommunication industry, cable, utilities, and technical service repair (e.g. appliance, HVAC). The invention is also useful for monitoring and controlling of processes that require accuracy, consistency and high level of quality control such as, for example, a process of managing a medical treatment.

Accomplishing automated interactive data processing in an environment of a mobile work force equipped with handheld mobile devices is technically difficult since such mobile devices cannot display (due to the limitations of their size) large amounts of data/information.

The products and methods of the present invention (which are preferably executed in a computer system) advantageously allow for (i) collection of work related information (e.g. data collection) while the work is in progress; (ii) real-time interaction with the person(s) performing the job as the work is progressing including the ability of manager(s)/supervisor(s) to provide feedback and actions targeted to optimize the completion of a job; and (iii) in the case of a mobile force equipped with handheld devices, real-time interactive data processing by providing segmented and sequential data transmission to and from the handheld device. To date, all work related information is collected post completion of the work. The methods described herein may be partially or fully automated further contributing to increased work productivity, predictability, consistency and/or quality, and improved work management.

The advantage of data collection of the invention is that it allows for monitoring of the worker (e.g. technician), and the prompting of him as appropriate, thus enabling collecting of critical information as the work is being performed. Consequently, the system is able to make intelligent, context sensitive, dynamic decisions to track, supervise and control the work, thus providing increased predictability. Such data collection, particularly automated data collection, is not done today and all work related information is collected post completion of the work. The invention also provides for feedback to both the worker (e.g. technician) and the work manager/supervisor. For example, the work manager gets near real time feedback on actual task performed and can thus correct and optimize the planning and therefore the predictability, and the worker is given near-real-time feedback on his work schedule compared to the target goal, compared to his peers and compared to other relevant metrics. The data collected using the above approach may also be used for any subsequent analysis and reports concerning various aspects of the work. Such objectives are met by the present invention, which for example may be a software and/or network centric application.

In certain embodiments, the invention provides for a work breakdown study. In other embodiments, a previously completed work breakdown study is provided for use in the invention. A job is decomposed into its logical segments, smaller and discrete work assignments, i.e., tasks (or steps). Qualifying characteristics, for example duration of time to complete a task, an order in which several tasks are to be performed, the data to be collected as part of completing the task, the level of criticality of the task or a level of skill required to perform the task, may be assigned to any/each particular task. A person of skill in the art (e.g. project and/or process management and/or industrial engineering) can conduct such a study using knowledge generally known in the art. For example, time to complete the task may be based on the generally acceptable and/or feasible time requirements in a particular field of work. Efficiency studies may also be performed to assess the optimal sequence of tasks in a particular job and their qualifying parameters.

To facilitate work progress tracking and/or quality control, milestones (e.g. progress monitoring and/or action triggering points) may be assigned to each job. Furthermore, the work, project or process manager may require certain “actions” to be taken when the work is not proceeding according to the schedule, for examples, reminder notifications may be sent to the person performing the work, alerts may be sent to a supervisory force, and/or escalations may be send to higher level management (e.g. when the job progress is not responding to reminders and alerts to supervisors/lower level managers). Generally, the work breakdown study may incorporate the required and/or desired communications or interactions between various parties to enable timely completion of a job. Such communication/interactions may be by any means of communication, for example, instant messaging, video conferencing, phone calls, computer messages. In case of a mobile force, any means of wireless communication may be used such as cell phones and other mobile computing devices (e.g. hand held computing devices, GPS, etc.).

The above described work breakdown and actions may be utilized to establish/create a job template. The job template may be created as part of the process of the invention or alternatively it may be created separately and provided for use in the present invention.

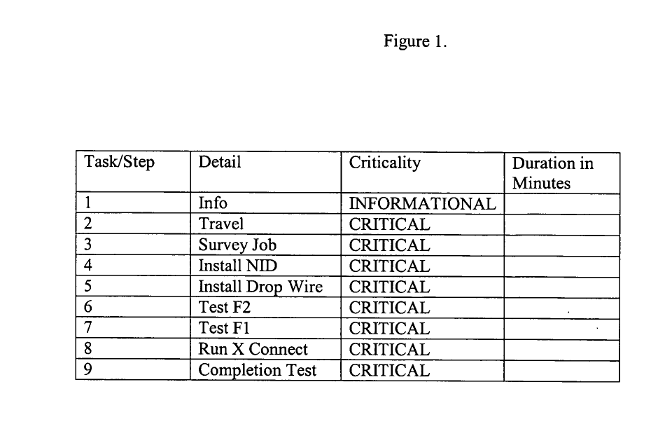

As used herein, a “job template” comprises tasks (including their qualifying features), milestones and actions (also referred to as “conditions;” depending on the work in progress as it compares with the predetermined or optimized schedule, e.g. reminders, alerts, escalations), and optionally various rules enabling data collection and interaction among various parties involved in work execution and management. Thus, a job template is structured for interactive data processing. For example, a job template may comprise a compilation of predefined tasks and their qualifying features, such as, for example, the duration of time assigned for the execution of a task, the order in which the task is to be executed in a series of task, or the criticality of the task. The job template may also include milestones, and various reminders, alerts, escalations and other notifications (e.g. successful completion of a task or job or meeting of a milestone) and related rules enabling interactive data processing. Milestones may coincide with a completion of a task, e.g. a critical step relevant for the work progress. Reminders, alerts to supervisors, escalations to higher level management and other actions and notifications are processed depending on rules enabling collection of data, monitoring of triggering events for such actions and notifications and transmitting and receiving of information. All jobs performed by a work organization can be mapped to such job templates. Fragments of a job template are also within the scope of the invention. An example of a job template fragment in represented in FIG. 1, which exemplifies a list of task and related information. The smallest fragment of a job template is a single task or step in the work process. Referring to FIG. 1, “travel” or “survey job” or “install drop wire” are such single step job template fragments.

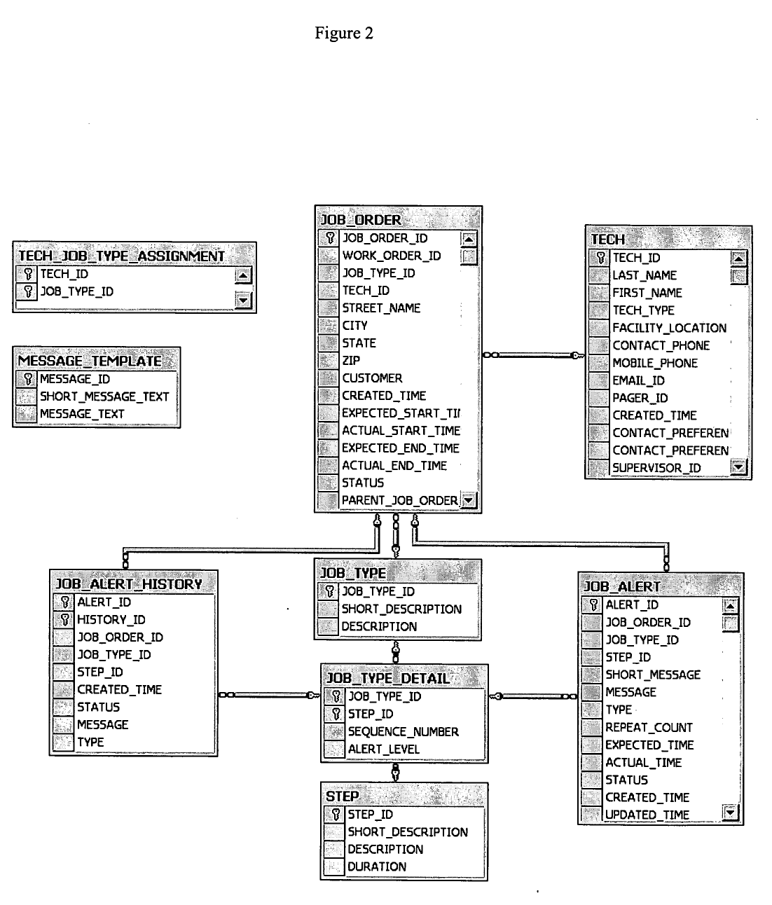

FIG. 2 represents an exemplary data model of a job template fragment.

Job templates may be stored in any medium, preferably in a storage medium that allows for automation of the methods of the invention. In certain embodiments, job templates are stored in a computer-readable medium. Thus, the invention encompasses a storage medium comprising at least one job template, for example a computer-readable storage medium comprising at least one job template. Examples of computer readable media for use in various aspects of the present invention include recordable-type media such a floppy disc, a hard disk drive, a RAM, and CD-ROMs and transmission-type media such as digital and analog communications links.

Also included are a computer program product (e.g. in a computer readable medium), a memory device, a processor or a system, each comprising a job template. A job template may comprise at least one task, at least one milestone, at least one action and at least one rule for interactive data processing. In case of complex and/or unpredictable jobs, a job template will comprise a plurality of tasks, one or more milestone(s) (e.g. a plurality of milestones), one or more actions (e.g. a plurality of actions), and one or more rule(s) (e.g. plurality of rules) for interactive data processing In one embodiment, a job template or a fragment thereof is stored in a central processor. In another embodiment, a remote device (e.g. a hand held device) comprises a job template or a fragment thereof. A person of skill in the art will be able to define/create logical job template fragments using guidance provided herein and general knowledge in data processing and/or work management art.

A library of job templates (i.e., template library) can be created and stored in any medium. For example, job templates may be stored in a database on a computer-readable medium. Thus, the invention also relates to a database comprising stored job templates or a database comprising a plurality of job templates. Also included is a processor, for example a central processor, comprising a plurality of job templates. In one embodiment, the database of the invention comprises job templates adapted to telecommunication industry, cable, utilities, and technical service repair (e.g. appliance, HVAC). In another embodiment, the database comprises job templates adapted to the process of managing a medical treatment. A process for generating a job template and a process for generating a library of job templates is also within the scope of the invention. The process may optionally include the work breakdown study. In certain embodiments, the process comprises the step of creating or writing a computer program for a job template and repeating the step as needed.

Also within the scope of the invention is a software tool for designing and/or building of a job template and/or a job template library. In certain embodiments, the software tool is being used to develop job templates/job template libraries for mobile device applications. Examples of mobile devices are handheld mobile devices, e.g. PDA devices, Blackberry™ devices.

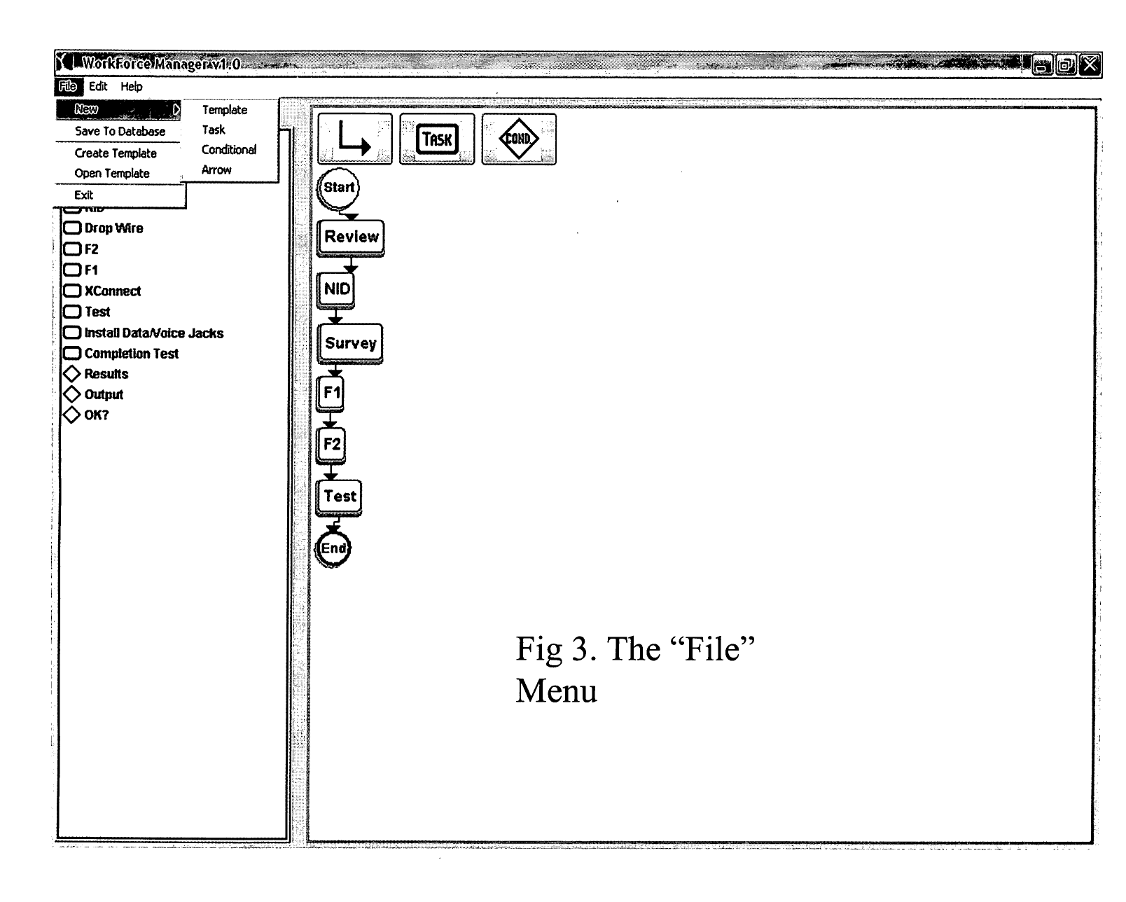

Referring to FIGS. 3-8, the software tool provides for customized design and building of work step/task libraries, work flow/process charts and job template libraries. The tool comprises a data input function and a data recording, storage and retrieval function, and allows for ease of use by providing drop-down menus and drag-and-drop options.

Customized (i.e., adapted for use in a particular industry) step/task libraries may be built in parallel to building work flow charts and template libraries, but since each step/task represents an independent data item, the steps/tasks from a preexisting step/task library may be used for any subsequent template library construction. For example, in some embodiments, a task/step may be selected from the task/step library, dragged and dropped in the work flow chart.

As used herein, a “step library” or a “task library” is a collection of individual tasks/steps, i.e., smaller and logical increments of a complete job. As described above, such steps/tasks can be identified using a work process study. For example, in a telecommunications industry, a job may require that a technician installs VOIP, install a phone line, or repair a phone line problem at a customer site. Such jobs may be decomposed into tasks/steps such as travel, survey of the job, installation of a wire, replacement of a wire, installation of voice jacks, and conducting of completion tests. Further examples of tasks/steps are shown in FIG. 1.

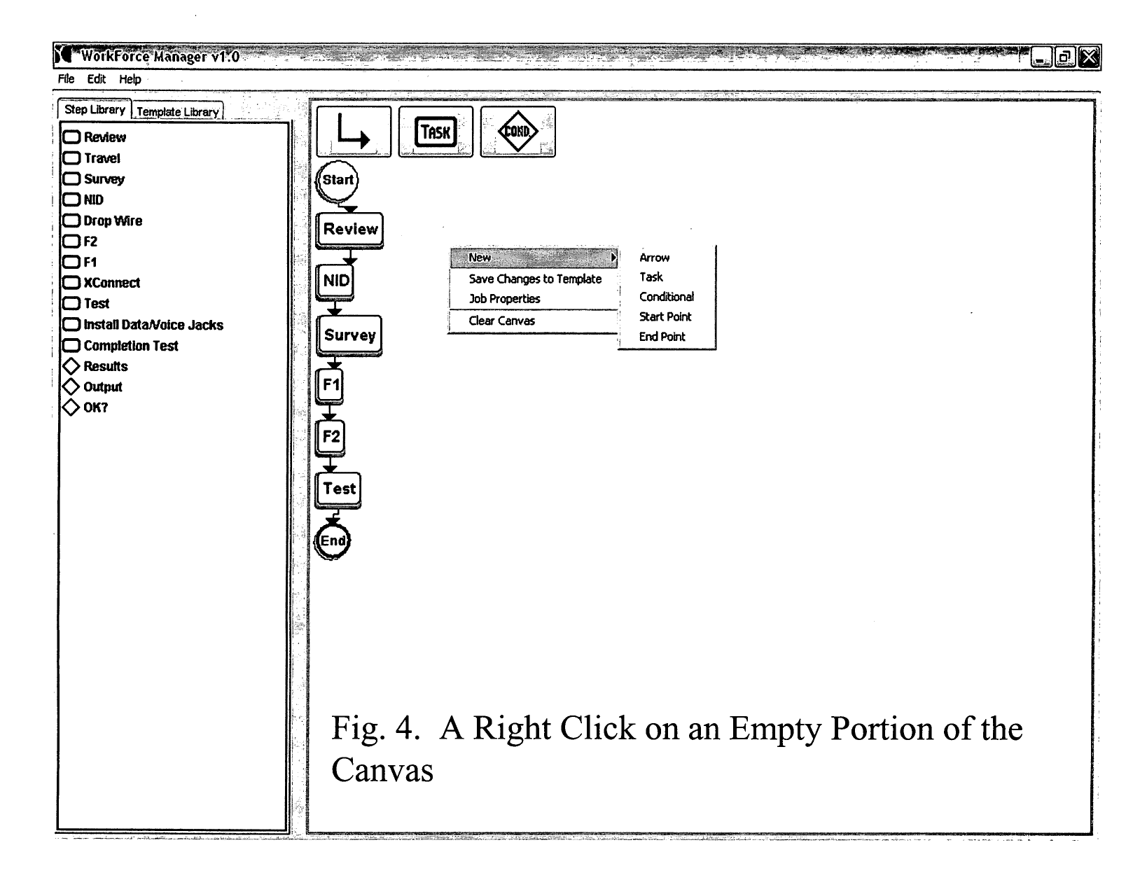

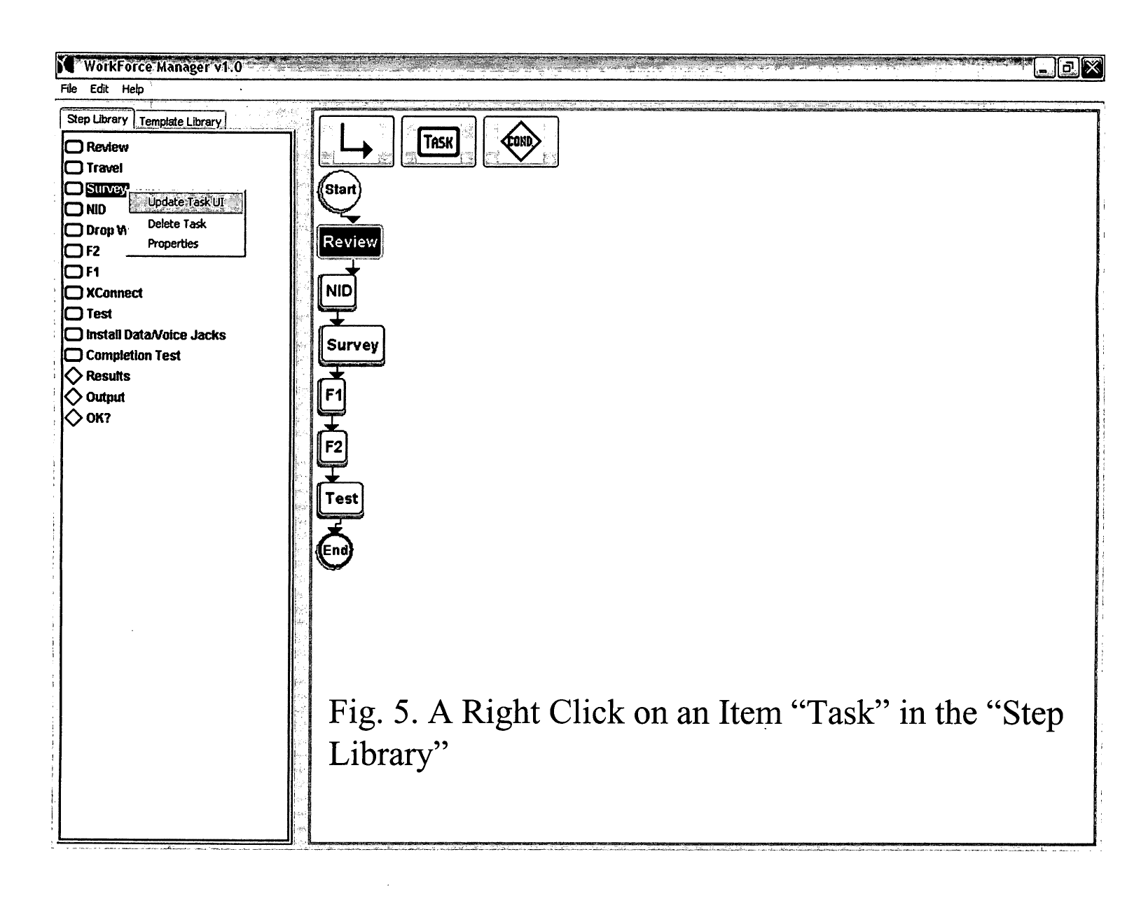

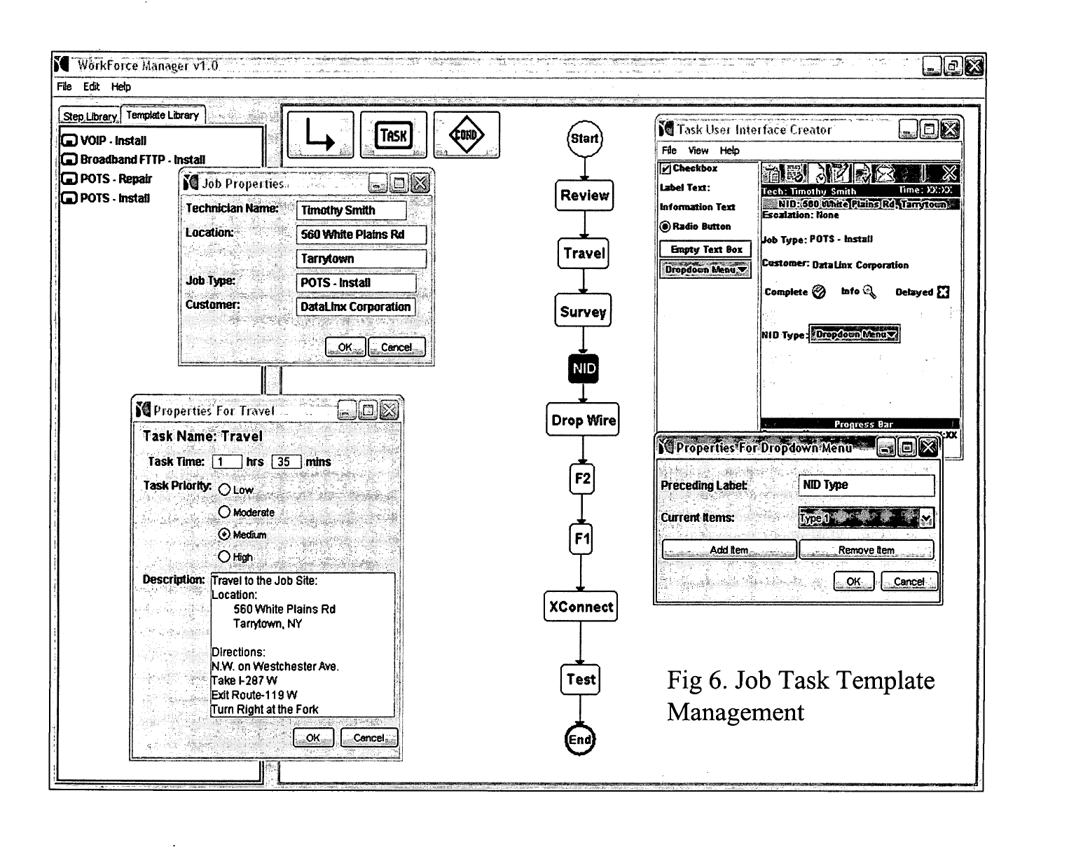

The software tool of the invention comprises step/task means, i.e., means for creating, naming, updating, and/or deleting a step/task and/or assigning properties to the step/task. In some embodiments, a new step/task may be created by selecting “new task” from a “file” pull down menu (FIG. 3), by positioning a pointing device over a “task” icon on the software tool display, or by pressing a right button on a mouse (FIG. 4). Steps/tasks may be deleted, updated or assigned properties using similar approaches (FIG. 5). Various parameters and/or properties may be assigned to each step/task, for example, expected duration of the task, task priority (e.g. low, moderate, medium, high), and description. An example of properties assigned to the “travel” task are shown in FIG. 6.

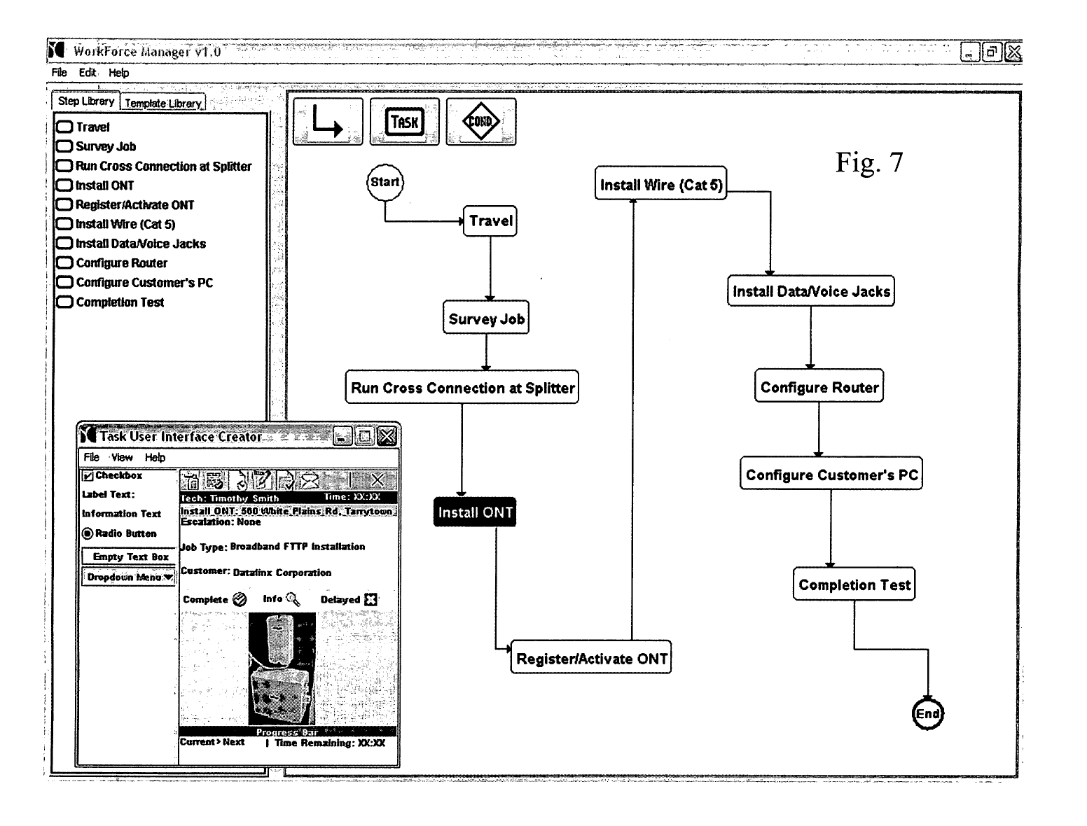

The tool may also comprise a task user interface creator, i.e., means for creating a user interface (e.g. designing user screen display layout and configuration for a mobile handheld device). The particulars of a step/task to be transmitted to the user (e.g. technician in charge of performing a job) and an interactive display to be displayed on a user processor, for example, handheld mobile device may be customized using the user interface means (e.g. FIGS. 6 and 7). The user interface creator may provide a capability to minimize user's (e.g. technician's) training by providing on a user processor display diagrams, methods and procedures for a particular step/task, see e.g. FIG. 7. It may also provide to the user the capability of using single key strokes to update the status of a job or obtain more information (see FIG. 7 e.g. complete, info or delayed key strokes).

The software tool of the invention also comprises connector means or work flow chart means, i.e., means for creating a work flow chart or means for defining the order/sequence in which the job steps/tasks are to be performed in a particular work process/job. Referring to FIGS. 3-4, the connectors may be accessed as described above for the tasks (connectors are referred to and depicted as arrows).

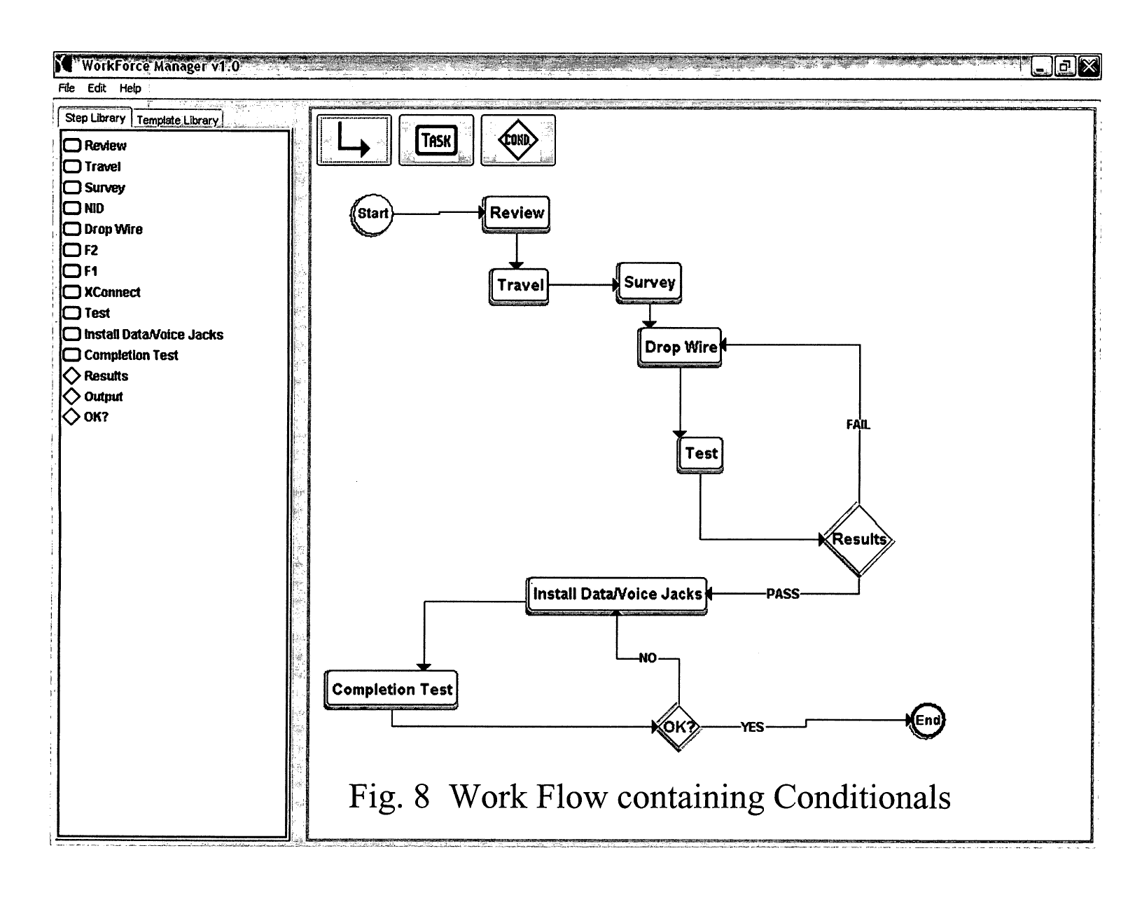

The software tool of the invention also comprises condition means, i.e., means for creating, naming, updating, deleting a condition in a work process and/or assigning properties to the condition. Failing to meet a condition (which may have a property of a milestone) may trigger actions (e.g. reminders to user, and alerts or escalations to management). An example of a work flow having a condition is represented in FIG. 8, requiring the passing of a test in order to move forward to the next step/task.

The software tool of the invention may also comprise means for storing and/or retrieving steps/task and job templates.

As desired or required, for example, when a work order is generated or when requested by a person performing the work, an individual job template relevant to the job to be completed, or a fragment thereof, is communicated to a person(s) in charge of job completion, e.g. a technician. Any mode of communication may be used. In certain embodiments, the requisite job template or a fragment thereof is transmitted to a processor accessible to the work person. For example, a central processor may transmit the relevant job template or a fragment thereof to one or more remote devices. The remote apparatus may display tasks and/or milestones and/or actions and/or other information relevant to data collection and processing.

In certain embodiments, the invention is a system comprising at least one central processor and one or more remote devices, wherein the central processor comprises a plurality of job templates and the remote devise is operably linked to the central processor. As used herein, “operably linked” means that, when a job is in progress, the central processor and at least one remote device communicate (e.g. receive and transmit information regarding the progress of a job). Examples of transmitted/received information are: job templates or fragments thereof, completion of tasks, reaching of or failing to meet milestones, reminders in follow up to missed milestones, alerts to supervisory personnel regarding missed milestones, escalations to higher level management, or notification of a completed job.

In another embodiment, the invention is a system for monitoring and controlling work progress, which system performs the following steps: (i) transmitting and/or receiving a job template or a fragment thereof for a job to be performed; (ii) collecting data regarding the progress of work on a task and/or reaching of a milestone; (iii) comparing the data collected in step (ii) with a job template or a fragment thereof; (iv) when a discrepancy occurs between the collected data and the job template or the fragment thereof, generating and transmitting an action (e.g. reminder, alert, escalation) based on predetermined rules in the job template or the fragment thereof, and (v) repeating the above steps until the job is completed or postponed for future handling.

In yet another embodiment, the invention is a user processor performing the following steps: (i) receiving and/or displaying a job template or a fragment thereof; (ii) collecting data regarding completion of task(s) and/or reaching of milestone(s); (iii) transmitting data collected in step (ii) according to a predefined rule in a job template or a fragment thereof; and (iv) optionally receiving an action (e.g. reminder). An action represents a feedback for the worker. The above steps may be repeated until the job is completed or postponed for future handling.

In yet another embodiment, a processor (e.g. a central processor) performing the following steps is provided: (i) optionally receiving request for a job from a worker, and optionally assessing the skill level of the worker; (ii) transmitting a job template or a fragment thereof; (iii) receiving data collected regarding the progress of work on a task and/or reaching of a milestone; (iv) comparing the data received in step (iii) with a job template or a fragment thereof; (v) when a discrepancy occurs between the collected data and the job template or the fragment thereof, generating and transmitting an action (e.g. reminder, alert, escalation) based on predetermined rules in the job template or the fragment thereof; and (v) repeating the above steps until the job is completed or postponed for future handling.

In one embodiment, the system of the invention comprises (i) a central processor comprising an application loader, and (ii) a user processor comprising an application controller. The user processor may be, for example, a remote mobile device (e.g. hanheld mobile device) operably linked to the central processor, for example, the remote mobile device may be operably linked to the central processor using wireless communication means.

An “application loader” is a software application which enables the central processor to communicate (transfer and receive) data to the user processor, to collect and/or process data, and to transmit/communicate a job template fragment (e.g. single step fragment) to the user processor. The central processor may perform the following steps: (i) optionally receiving a request for a job from a user processor; (ii) identifying a job to be performed; (iii) accessing a database of job templates; (iv) selecting a job template relevant to the job to be performed; (v) sending a job template or a fragment thereof to the user processor; (vi) collecting data regarding the status of the job; (vii) comparing data collected in step (vi) with the job template or the fragment thereof; (viii) when a discrepancy occurs between the collected data and the job template or the fragment thereof, generating and transmitting an action based on predetermined rules in the job template or the fragment thereof; and (ix) repeating the above steps until the job is completed or postponed for future handling.

In the optional step (i) in which a user (e.g. technician) requests a job via a user processor, the application loader may perform an additional step of identifying the user (e.g. technician) and assessing the user's qualifications/skill level and selecting a job that can be performed by that user. In the above step (ii), the central processor may receive job information from another processor in the system. Selecting the job template in step (iv) may be performed, for example, using certain key words. In step (v), the application loader may send the entire job template. However, in the work environments where mobile force is using handheld devices, it is advantageous to send a fragment of a job template. In some embodiments, a single task/step is sent to the mobile device. For example, in a particular job requiring VOIP installation at a customer site, the central processor will preferably communicate the “travel step” first (e.g. customer address and optionally travel directions); the next fragment (e.g. survey job) will be communicated only after the user and user processor communicate that the task of travel was completed. Application loader may perform any other step described herein.

Step (vi) above may involve tracking and/or recording of job fragment parameters (e.g. time required for task completion) and/or receiving the job fragment status data from the user processor. If no status data are received, and a certain milestone present in a job template is reached (e.g. the predetermined time for travel to customer site has expired), an application loader may communicate a reminder (or act on another action item, e.g. send an escalation to the management) depending on the conditions set in the job template. If status data are received from the user processor, the application loader will compare the data with a job template and if the task is completed, will communicate the next job fragment.

An “application controller” is a software application which enables the user processor to communicate (transfer and receive) data to the central processor, to collect and/or process data, and to receive and/or display a job template fragment (e.g. single step/task template). The application controller may perform the following steps: (i) optionally sending a request for a job; (ii) receiving a job template or a job template fragment; (iii) displaying a job template or a job template fragment on a display screen of the user processor; (iv) receiving input information from a user; (iii) communicating input information to central processor; (iv) repeating the above steps until completion of the job. The application controller may perform any other user related steps.

Also within the scope of the invention is a method of monitoring and controlling work progress and/or optimizing work/job/process management comprising the steps of: (i) for a job to be performed, communicating a job template or a fragment thereof to a work person (e.g. technician); (ii) collecting data regarding the progress of work on a job template task and/or reaching of a job template milestone; (iii) comparing the data collected in step (ii) with a job template or a fragment thereof; (iv) when a discrepancy occurs between the collected data and the job template or the fragment thereof, generating and transmitting an action (e.g. reminder, alert, escalation) based on predetermined rules in the job template or the fragment thereof; and (v) repeating the above steps until the job is completed or postponed for future handling.

Various combinations of method steps and/or products (e.g. article of manufacture, apparatus) described in this applications are within the scope of the invention as it will be apparent to a person of skill in the art. All methods described herein may be executed in a computer system.

1. A system for interactive data processing comprising:
(i) a central processor comprising an application loader, and
(ii) a user processor comprising an application controller.

2. The system of claim 1, wherein the application loader performs the following steps:
(i) optionally receiving a request for a job from a user processor;
(ii) identifying a job to be performed;
(iii) accessing a database of job templates;
(iv) selecting a job template relevant to the job to be performed;
(v) sending the job template or a fragment thereof to the user processor;
(vi) collecting data regarding the status of the job;
(vii) comparing data collected in step (vi) with the job template or the fragment thereof;
(viii) when a discrepancy occurs between the collected data and the job template or the fragment thereof, generating and transmitting an action based on predetermined rules in the job template or the fragment thereof; and
(ix) repeating the above steps until the job is completed or postponed for future handling.

3. The system of claim 2, wherein the application loader optionally performs the step of assessing the skill level of the user requesting the job via the user processor.

4. The system of claim 2, wherein the step (v) comprises sending a job template fragment which is a task.

5. The system of claim 2, wherein the action is a reminder, an alert or an escalation.

6. The system of claim 2, wherein the application controller performs the following steps: (i) optionally sending a request for a job; (ii) receiving a job template or a job template fragment; (iii) displaying a job template or a job template fragment on a display screen of the user processor; (iv) receiving input information from the user; (v) communicating input information to the central processor; (iv) and repeating the above steps until the job is completed or postponed for future handling.

7. The system of claim 6, further comprising the step of optionally receiving an action from the central processor.

8. The system of claim 2, wherein the user processor is a remote mobile device operably linked to the central processor.

9. The system of claim 8, wherein the remote mobile device is operably linked to the central processor using wireless communication means.

10. The system of claim 9, wherein the remote mobile device is a handheld device comprising a job template fragment.

11. The system of claims 1 further comprising a data storage medium comprising a plurality of job templates.

12. A system for monitoring and controlling work progress, which system comprises a central processor and a user processor, and which system performs the following steps: (i) transmitting and/or receiving a job template or a fragment thereof for a job to be performed; (ii) collecting data regarding the progress of work on a task and/or reaching of a milestone; (iii) comparing the data collected in step (ii) with a job template or a fragment thereof; (iv) when a discrepancy occurs between the collected data and the job template or the fragment thereof, generating and transmitting an action (e.g. reminder, alert, escalation) based on predetermined rules in the job template or the fragment thereof; and (v) repeating the above steps until the job is completed or postponed for future handling.

13. The user processor of claim 12 performing the following steps: (i) receiving and/or displaying a job template or a fragment thereof; (ii) collecting data regarding completion of task(s) and/or reaching of milestone(s); (iii) transmitting data collected in step (ii) according to a predefined rule in a job template or a fragment thereof; and (iv) optionally receiving an action.

14. The central processor of claim 12 performing the following steps: (i) optionally receiving a request for a job from a worker, and optionally assessing the skill level of the worker; (ii) transmitting a job template or a fragment thereof; (iii) receiving data collected regarding the progress of work on a task and/or reaching of a milestone; (iv) comparing the data received in step (iii) with a job template or a fragment thereof; (v) when a discrepancy occurs between the collected data and the job template or the fragment thereof, generating and transmitting an action (e.g. reminder, alert, escalation) based on predetermined rules in the job template or the fragment thereof; and (v) repeating the above steps until the job is completed or postponed for future handling.

15. A software tool for designing and/or building a job template and/or a job template library comprising:
(i) means for creating, naming, updating, assigning properties to, and/or deleting a task;
(ii) means for creating a work flow chart; and
(iii) means for creating, naming, updating, assigning properties to, and/or deleting a condition.

16. The software tool of claim 15, wherein the conditions is a milestone or an action.

17. The software tool of claim 16, wherein the action is a reminder, an alert, or an escalation.

18. The software tool of claim 15 further comprising means for creating a user interface.

19. The software tool of claim 15 further comprising means for storing and retrieving a task or a job template.
